(19) United States
(12) Patent Application Publication
(10) Pub. No.: US 2017/0096612 A1
(43) Pub. Date: Apr. 6, 2017

(54) APPARATUS AND METHOD FOR PRECISE APPLICATION OF LUBRICANT ON COLLIMATOR COMPONENTS

(71) Applicant: VARIAN MEDICAL SYSTEMS, INC., Palo Alto, CA (US)

(72) Inventors: Stephen J. MOHR, Danville, CA (US); Jonathan EVANS, Mountain View, CA (US); David BUSECK, San Jose, CA (US); Robert KOPELS, Cupertino, CA (US); Christopher E. BROWN, Morgan Hill, CA (US); Steve DOWNEY, Morgan Hill, CA (US)

(73) Assignee: VARIAN MEDICAL SYSTEMS, INC., Palo Alto, CA (US)

(21) Appl. No.: 14/874,182

(22) Filed: Oct. 2, 2015

(51) Int. Cl. C10M 107/38; G21K 1/04

(52) U.S. Cl. CPC C10M 107/38; G21K 1/046

(57) ABSTRACT

A method of applying a lubricant onto a carriage box of a collimator includes: providing a mixture having a lubricant and a solvent; applying an amount of the mixture that includes a predetermined quantity of the lubricant onto a first set of guide rails at a first side of the carriage box; and removing the solvent from the mixture to leave the lubricant adhering to the surface. A kit for lubricating a collimator includes: a container housing a lubricating mixture having a lubricant mixed in a solvent; wherein a quantity of the lubricant is predetermined based, at least in part, on a first surface area of a first set of guide rails at a first side of a carriage box, a second surface area of a second set of guide rails at a second side of the carriage box, or both the first surface area and the second surface area.

### TECHNICAL FIELD

An embodiment described herein relates generally to application of lubricants, and in particular, to an apparatus and method for precise application of a lubricant on collimator components.

### BACKGROUND

Radiation therapy involves medical procedures that selectively expose certain areas of a human body, such as cancerous tumors, to high doses of radiation. The intent of the radiation therapy is to irradiate the targeted biological tissue such that the harmful tissue is destroyed. In certain types of radiotherapy, the irradiation volume can be restricted to the size and shape of the tumor or targeted tissue region to avoid inflicting unnecessary radiation damage to healthy tissue. For example, conformal therapy is a radiotherapy technique that is often employed to optimize dose distribution by conforming the treatment volume more closely to the targeted tumor.

A radiation therapy machine may have a collimator for changing a size and/or shape of a radiation beam, so that the radiation beam corresponds to a size and/or shape of a target region being treated. A collimator for a radiation therapy machine may include multiple leaves that are moveably supported in respective guide rails in a carriage box. A lubricant may be applied between the leaves and the guide rails to allow the leaves to move smoothly relatively to the guide rails. However, lubricant in the collimator has been known to fail because interaction with radiation and contaminants, which may change the characteristics of the lubricant. Also, direct radiation exposure on lubricant may dramatically shorten the life and effectiveness of the lubricant. Also, applying the right amount of lubricant onto the collimator guide rails and applying it uniformly has been a challenge. Over application of lubricant onto the collimator may cause the lubricant to be less effective and may turn the lubricant into sludge.

### SUMMARY

A method of applying a lubricant onto a carriage box of a collimator includes: providing a mixture having a lubricant and a solvent; applying an amount of the mixture that includes a predetermined quantity of the lubricant onto a first set of guide rails at a first side of the carriage box; and removing the solvent from the mixture to leave the lubricant adhering to the surface.

Optionally, the solvent comprises Vertrel XF, Hydrofluorocarbon (HFC) fluid, hydrochlorofluorcarbon (HCFC) fluid, perfluorocarbon (PFC) fluid, or chlorinated solvent fluid.

Optionally, the lubricant comprises perfluoropolyether (PFPE), polyphenyl ether (PPE), Krytox XP 2A5, or Krytox XP 2A7.

Optionally, the mixture is provided in a container, and wherein the act of applying comprises transferring the amount of the mixture from the container to the carriage box without requiring a user to measure the amount of the mixture.

Optionally, the mixture is provided in a container, and wherein the method further comprises measuring the amount of the mixture to be transferred from the container to the carriage box, the amount of the mixture to be transferred being less than a total amount of the mixture in the container.

Optionally, the mixture is provided in a container, and a total quantity of the mixture in the container has a sufficient amount of the lubricant to cover a first surface area of the first set of slots, a second surface area of a second set of slots at a second side of the carriage box, or both the first surface area and the second surface area.

Optionally, the mixture is provided in a container, a total quantity of the lubricant in the container being greater than the predetermined quantity by an excess amount.

Optionally, the act of applying the mixture is distributed evenly over the surface by tilting or oscillating the collimator carriage box.

Optionally, the method further includes verifying a distribution of the lubricant on the carriage box.

Optionally, the distribution of the lubricant is verified by using an ultraviolet light source.

Optionally, the method further includes determining an amount of the lubricant applied on the first set of guide rails.

Optionally, the method further includes cleaning the carriage box before applying the mixture onto the first set of guide rails.

Optionally, the method further includes applying the mixture onto a second set of guide rails at a second side of the carriage box, the second side being opposite from the first side.

Optionally, the mixture is provided in a first container, and wherein the method further comprises: providing an additional mixture in a second container; and applying at least some of the additional mixture onto a second set of guide rails at a second side of the carriage box, the second side being opposite from the first side.

Optionally, the method further includes: securing a first sealing component to a front side of the carriage box; and securing a second sealing component to a back side of the carriage box; wherein the first sealing component and the second sealing component, together with the first set of guide rails, form a tub.

Optionally, the first sealing material includes an opening.

A collimator includes: a carriage box having a first side and a second side opposite from the first side, the carriage box having a first plurality of slots at the first side for moveably accommodating respective leaves; and a lubricant comprising perfluoropolyether (PFPE) distributed on a surface area of the slots.

Optionally, the carriage box has a second plurality of slots at the second side for accommodating the leaves.

Optionally, the collimator further includes the leaves, wherein the leaves are moveably disposed in the respective slots.

Optionally, the lubricant has a thickness that is less than 12 microns.

Optionally, the lubricant comprises particles that light up in response to ultraviolet light.

A kit for lubricating a collimator includes: a container housing a lubricating mixture having a lubricant mixed in a solvent; wherein a quantity of the lubricant in the lubricating mixture is predetermined based, at least in part, on a first surface area of a first set of guide rails at a first side of a carriage box, a second surface area of a second set of guide rails at a second side of the carriage box opposite from the first side, or both the first surface area and the second surface area.

Optionally, the lubricant comprises perfluoropolyether (PFPE), polyphenyl ether (PPE), Krytox XP 2A5, or Krytox XP 2A7.

Optionally, the solvent comprises Vertrel XF, Hydrofluorocarbon (HFC) fluid, hydrochlorofluorcarbon (HCFC) fluid, perfluorocarbon (PFC) fluid, or chlorinated solvent fluid.

Optionally, the kit further includes a brush for cleaning the carriage box.

Optionally, the lubricating mixture comprises particles that light up in response to ultraviolet light.

Optionally, the kit further includes an ultraviolet light source for providing the ultraviolet light.

Optionally, the kit further includes a first sealing component for abutment against a front side of the carriage box.

Optionally, the kit further includes a first plate for supporting the first sealing component.

Optionally, the kit further includes a second sealing component for abutment against a back side of the carriage box.

Optionally, the quantity of the lubricant in the lubricating mixture has a first amount that is sufficient to cover at least the first surface area of the first set of guide rails, the second surface area of the second set of guide rails, or both the first surface area and the second surface area.

Optionally, the quantity of the lubricant in the lubricating mixture has a second amount that is in addition to the first amount, wherein the first amount and the second amount constitute a total amount of the quantity of the lubricant in the lubricating mixture.

A kit for lubricating an object includes: a container housing a lubricating mixture having a lubricant mixed in a solvent; wherein a quantity of the lubricant in the lubricating mixture is predetermined based, at least in part, on a surface area of the object that is desired to be lubricated.

A method of applying a lubricant onto an object includes: providing a mixture having a lubricant and a solvent; applying a predetermined quantity of the mixture onto a surface of the object; and removing the solvent from the mixture to leave the lubricant adhering to the surface of the object.

Other features, embodiments, and advantageous will be described in the detail description.

### BRIEF DESCRIPTION OF THE DRAWINGS

The drawings illustrate the design and utility of some features, in which similar elements are referred to by common reference numerals. These drawings are not necessarily drawn to scale. In order to better appreciate how the above-recited and other advantages and objects are obtained, a more particular description will be rendered, which are illustrated in the accompanying drawings. These drawings are not to be considered limiting in the scope of the claims.

FIG. 1 is a schematic diagram illustrating a radiation system that includes a collimator.

FIGS. 2A-2B are schematic diagrams illustrating an exemplary MLC carriage box.

FIG. 3A illustrates a container of a lubrication mixture.

FIG. 3B illustrates an example of a Stribeck curve.

FIG. 4 is a flow chart illustrating a process for application of a lubricant onto complex surfaces in a MLC carriage box.

FIGS. 5A-5B are schematic diagrams illustrating a MLC carriage box with sealing components.

FIG. 5C is a schematic diagram illustrating application of a mixture on complex surfaces in a MLC carriage box.

FIG. 5D is a schematic diagram illustrating evaporation of solvent from a mixture applied on complex surfaces in a MLC carriage box.

FIG. 6 is a flow chart illustrating an application process for repairing a MLC carriage box with lubrication.

FIG. 7 illustrates a lubrication kit for a MLC.

### DETAILED DESCRIPTION

Various features are described hereinafter with reference to the figures. It should be noted that the figures are not drawn to scale and that the elements of similar structures or functions are represented by like reference numerals throughout the figures. It should be noted that the figures are only intended to facilitate the description. They are not intended as an exhaustive description of the claimed invention or as a limitation on the scope of the claimed invention. In addition, an illustrated item need not have all the aspects or advantages shown. An aspect or an advantage described in conjunction with a particular item is not necessarily limited to that item and can be practiced in any other items even if not so illustrated.

Various techniques may be employed for applying lubricant onto guide rails in a carriage box of a collimator. One approach may involve applying a small amount of oil onto surfaces of the guide rails to be lubricated, and using compressed air to distribute the lubricant throughout the surfaces of the guide rails. The amount of the lubricant applied on the surfaces may be determined by weighing the object before and after lubrication. In order to achieve a desired amount of lubricant, some of the lubricant may be blown out of the carriage box to remove excess lubricant, or the lubrication process may be repeated if more lubricant is desired to be applied. Prior to the application of the lubricant, the surfaces of the guide rails may need to be coated with various surface treatments, such as anodization, molybdenum disulfide (MoS₂), or diamond-like carbon (DLC).

Another approach for application of lubricant onto the carriage box of a collimator involves use of a solvent plating or grease plating method. Such technique may involve dipping the object to be lubricated into a lubrication bath and removing the object at a controlled speed. The dipping process may be dependent on environmental factors (e.g., temperature, air flow). Also, the various factors (e.g., solution concentration, dipping speed) involved in controlling the process may make the dipping processes difficult to implement.

In the above techniques, the thickness and/or uniformity of the lubricant may not be precisely controlled. In addition, the above techniques may not involve verifying if the lubricant is evenly distributed on the surfaces that are desired to be lubricated. Also, the above techniques may not work well with greases, high viscosity oils, or other types of lubricant. In addition, the above techniques may not work well with complicated surface geometries, such as those in the guide rails of the carriage box of the collimator.

Embodiments of the present disclosure provide a method for applying a thin film of a lubricant onto complex guide rail surfaces of a carriage box of a collimator in a precise manner. A quantity of the lubricant is first determined based, at least in part, upon the surface area of the complex guide rail surfaces at the carriage box. The lubricant with the predetermined quantity is then mixed with a solvent to create a lubrication mixture. The lubrication mixture is applied onto the complex surfaces of the guide rails at the carriage box of the collimator to make an even distribution of the mixture over the surfaces. The solvent in the lubrication mixture is then removed to leave the lubricant adhering to the surfaces of the guide rails. Since the quantity of the lubricant is pre-determined based, at least in part, upon a surface area of the complex surfaces of the guide rails, the method may precisely control the thickness of the lubricant applied onto the guide rail surfaces. In one implementation, the surface area of the surfaces desired to be coated with lubricant is determined. Also, a desired thickness of the lubricant is determined. The product of the surface area and the desired lubricant thickness provides volume of the lubricant that is needed to cover the surfaces. The volume is then multiplied by a density of the lubricant to obtain the weight of the lubricant that is needed to cover the surfaces.

In some cases, during the lubricant application process, some amount of lubricant may be lost or may be unable to be delivered to the target surface (e.g., due to the lubricant adhering to container, delivery tube, etc.). In such cases, empirical testing of the lubricant application may be performed to determine an additional amount of lubricant that may need to be provided in order to make up such difference.

In addition, in some cases, the method described herein may optionally include verifying the distribution of the lubricant with a UV light source.

Radiation Systems

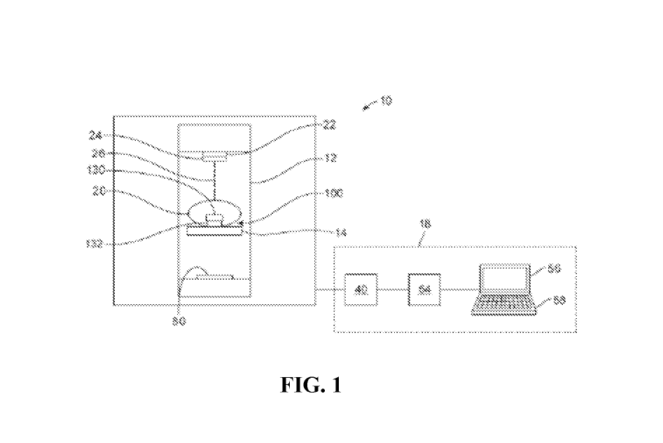

FIG. 1 illustrates a radiation treatment system 10. The system 10 includes an arm gantry 12, a patient support 14 for supporting a patient 20, and a control system 18 for controlling an operation of the gantry 12 and delivery of radiation. The system 10 also includes a radiation source 22 that projects a beam 26 of radiation towards the patient 20 while the patient 20 is supported on support 14, and a collimator system 24 for changing a cross sectional shape of the radiation beam 26. The radiation source 22 may be configured to generate a cone beam, a fan beam, or other types of radiation beams in different embodiments. Also, in other embodiments, the source 22 may be configured to generate proton beam as a form of radiation for treatment purpose. Also, in other embodiments, the system 10 may have other form and/or configuration. For example, in other embodiments, instead of an arm gantry 12, the system 10 may have a ring gantry 12.

In the illustrated embodiments, the radiation source 22 is a treatment radiation source for providing treatment energy. In some embodiments, the radiation source 22 may be a treatment radiation source for providing treatment energy, wherein the treatment energy may be used to obtain images. In such cases, in order to obtain imaging using treatment energies, an imager 80 is configured to generate images in response to radiation having treatment energies (e.g., MV imager).

In the illustrated embodiments, the control system 18 includes a processing unit 54, such as a processor, coupled to a control 40. The control system 18 may also include a monitor 56 for displaying data and an input device 58, such as a keyboard or a mouse, for inputting data. The operation of the radiation source 22 and the gantry 12 are controlled by the control 40, which provides power and timing signals to the radiation source 22, and controls a rotational speed and position of the gantry 12, based on signals received from the processing unit 54. Although the control 40 is shown as a separate component from the gantry 12 and the processing unit 54, in alternative embodiments, the control 40 can be a part of the gantry 12 or the processing unit 54.

In some embodiments, the system 10 may be a treatment system configured to deliver treatment radiation beam towards the patient 20 at different gantry angles. During a treatment procedure, the source 22 rotates around the patient 20 and delivers treatment radiation beam from different gantry angles towards the patient 20. While the source 22 is at different gantry angles, the collimator 24 is operated to change the shape of the beam to correspond with a shape of the target tissue structure. For example, the collimator 24 may be operated so that the shape of the beam is similar to a cross sectional shape of the target tissue structure.

In some embodiments, the collimator 24 is a multileaf collimator (MLC) for creating an irregularly shaped field to the shape of a target. The MLC is made up of individual beam blocking leaves of a high atomic numbered material (e.g., tungsten). MLCs may have about 40-120 leaves, arranged in pairs. In other embodiments, the number of leaves in a MLC may be fewer than 40 or more than 120. Each individual MLC leaf may move independently in and out of the path of a radiation beam to block some fractions of the beam. Any desired field shape may be generated by moving and controlling a large number of narrow, closely abutting individual leaves. In some embodiments, the MLC leaves move on a carriage box along respective guide rails.

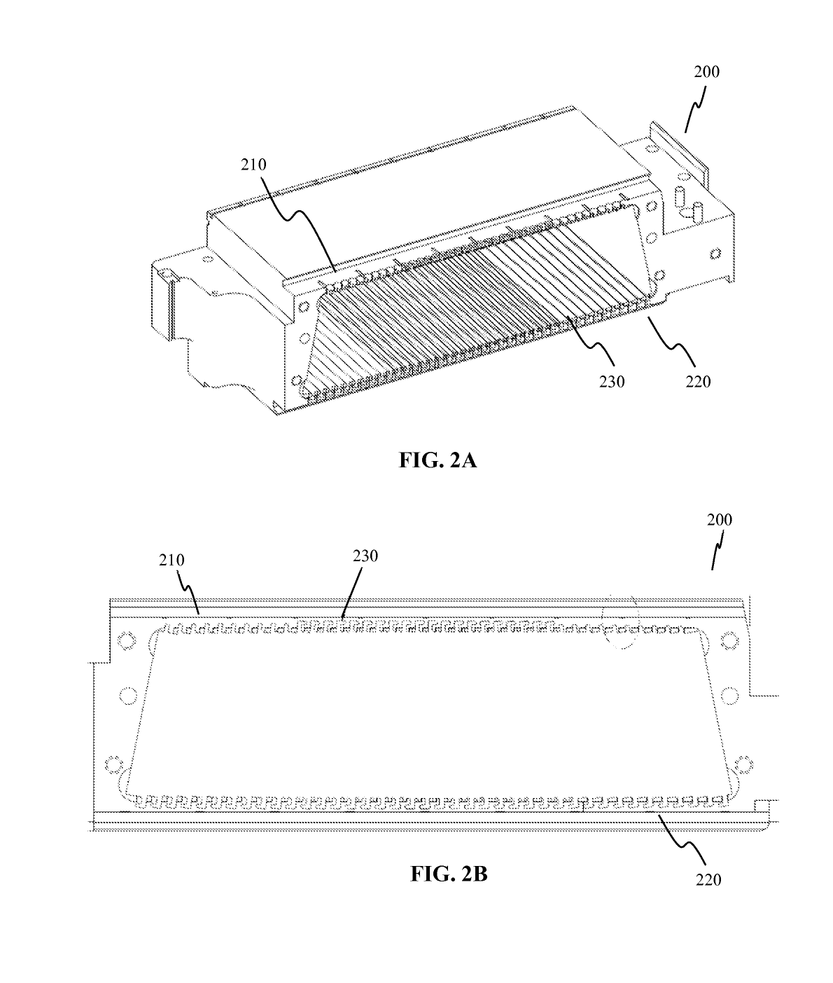

FIGS. 2A and 2B are schematic diagrams illustrating an exemplary MLC carriage box 200 in different views. In some cases, the carriage box 200 may be a part of the collimator 24. The carriage box 200 may be made from aluminum, or another material. Inside the carriage box 200, there is a top side 210 and a bottom side 220. The top and bottom sides 210, 220 includes a plurality of guide rails (or slots) 230. In the illustrated embodiment, the guide rails 230 have long, narrow grooves for accommodating individual leaves. Since MLC leaves move on the guide rails 230, it requires lubrication on the guide rails 230 to reduce the wear of or friction between the moving leaves and the guide rails 230.

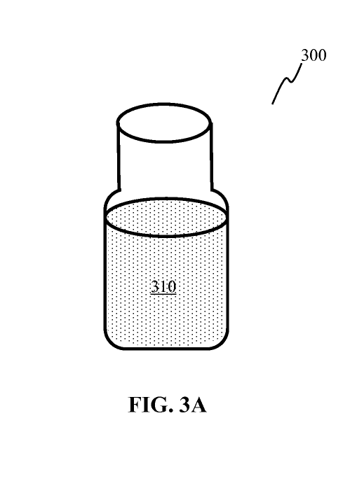

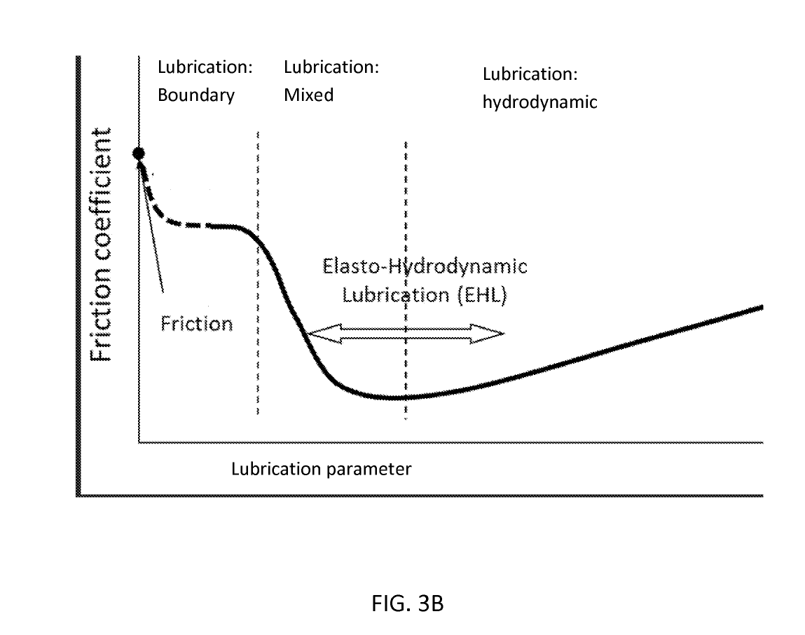

According to some embodiments of the present disclosure, a lubrication mixture is prepared in advance. FIG. 3A shows a container 300 housing a lubrication mixture 310. The lubrication mixture 310 comprises a lubricant and a solvent. The lubricant is a radiation resistant lubricant. In other words, the lubricating properties of the lubricant are relatively stable (e.g., it does not harden, dry up, and/or form solid particles) when it is exposed to radiation. In one implementation, the lubricant comprises a perfluoropolyether (PFPE), e.g., NyeTact® Lubricant 571H-10, or NyeTact® Lubricant 570H-25. In some embodiments, the lubricant may comprise polyphenyl ether (PPE). In further embodiments, the lubricant may comprise Dupont Krytox XP 2A5 or Krytox XP 2A7. In other embodiments, the lubricant in the mixture 310 may include other materials.

The quantity of the lubricant to be applied may be pre-determined based at least in part upon the surface area of the object to be lubricated (e.g., the surface area of the guide rails at one side or both sides of the carriage box 200). In one embodiment, the quantity of the lubricant is sufficient to cover the area of the surfaces of the guide rails with a desired thickness of the lubricant. The desired thickness of the lubricant to be created on the surface area of the guide rails may be determined based on the surface roughness of the sliding contact surfaces (surface of collimator leaf and surface of guide rail). In some cases, the lubricant thickness is based on (e.g., proportional to) the sum of the squares of the composite roughnesses of the surfaces moving relative to each other. For example, in some embodiments, the lubricant thickness may be determined to be equivalent to 3.5+/−0.5 composite roughness values (Alpha) of the two mating surfaces. In other embodiments, the lubricant thickness may be equivalent to other composite roughness values.

In one technique, the desired thickness of the lubricant to be created on the surfaces of the guide rails may be determined using a Stribeck curve (FIG. 3B). As shown in the figure, the Stribeck curve indicates the relationship between the relative friction coefficient and a lubrication parameter (e.g., the thickness of the lubricant). If the lubricant thickness is too low, there will be high friction between the leaves and the guide rails. On the other hand, if the lubricant thickness is too high, hydrodynamic lubrication results and the system may have more lubrication than needed. Also, if the lubricant thickness is excessive, the lubricant may migrate between parts, causing mechanism in the collimator to jam. As shown in the Stribeck curve, there is an optimal thickness of the lubricant that would provide the lowest friction coefficient. In some cases, the optimal thickness associated with the lowest friction coefficient may be selected as the desired thickness for the lubricant to be created on the surfaces of the guide rails. In other cases, the desired thickness for the lubricant to be created on the surfaces of the guide rails may be slightly (e.g., 2%, or more preferably 5%, or even more preferably 10%) above that associated with the lowest friction coefficient. Selecting a thickness that is slightly above that associated with the lowest friction coefficient may be advantageous because it provides a factor of safety to account for the possibility of under-lubrication. In one embodiment, the thickness of the lubricant to be created on the surfaces of the guide rails in the carriage box is less than 12 microns, and more preferably about 9-10 microns (e.g., 9.5 microns±2 microns). In other techniques, instead of using a Stribeck curve, surface topography of the leaf and guide rail may be examined to determine how much thickness of lubricant is needed.

Also, in other embodiments, the desired thickness of the lubricant to be created on the surface of the guide rails may be determined experimentally through trial and error. For example, an initial thickness for the lubricant may be determined and created on the guide rails; then the mechanical behavior of the collimator is examined to determine if the thickness is adequate. If not, then a revised thickness for the lubricant is determined and created on guide rails. The method may then be repeated until a desired thickness for the lubricant is determined.

In other embodiments, a test strip (e.g., a coupon) may be attached to the guide rails, and lubrication is then applied onto the test strip. The test strip with the lubricant attached thereto may then be removed from the carriage box. The weight of the lubricant may then be determined by subtracting the weight of the test strip (without the lubricant) from the weight of the test strip with the lubricant. The volume of the lubricant can be calculated by dividing the weight of the lubricant from the density of the lubricant. The thickness of the lubricant may then be calculated by dividing the volume of the lubricant from the surface area of the test strip (which represents the surface of the guide rails).

Once the desired thickness for the lubricant is determined, the quantity (e.g., volume) of the lubricant can be calculated by multiplying the determined thickness by the surface areas to be lubricated. If the quantity is desired to be determined in terms of weight, the determined volume of the lubricant may be multiplied by the density of the lubricant. This quantity Q1 is the quantity of lubricant that is needed in order to provide a desired thickness of lubricant covering the guide rails of the carriage box 200.

In some cases, the quantity Q1 of the lubricant is sufficient to cover at least the first surface area of a first set of guide rails on a first side of the carriage box. In other cases, the quantity Q1 of the lubricant is sufficient to cover at least a second surface area of a second set of guide rails on a second side of the carriage box, the second side being opposite from the first side. In other cases, the quantity Q1 of the lubricant is sufficient to cover at least both the first surface area of the first set of guide rails on the first side of the carriage box, and the second surface area of the second set of guide rails on the second side of the carriage box.

In some cases, during application process, some amount of the lubricant may be lost or may be unable to be delivered to the target surface (e.g., due to the lubricant adhering to container, delivery tube, etc.). For example, after the mixture 310 is removed from the container 300 during an application process, there may be some amount of the mixture 310 that is left in the container due to surface adhesion, etc. Thus, in some embodiments, the quantity of the lubricant to be placed in the container 300 may be determined to consider such effect. For example, the quantity QT (total quantity) of the lubricant to be placed in the container 300 may include an excess amount Q2 that is in addition to the amount Q1 sufficient to cover a surface area of the guide rails (e.g., QT=Q1+Q2). In some embodiments, the excess amount Q2 may be determined empirically. In particular, empirical testing of the lubricant application may be performed to determine an additional amount of lubricant that may need to be provided in order to make up the difference. For example, a carriage box (which may be a model or an actual carriage box) may be used to test different quantities QT of the mixture 310 to determine an amount QT that is sufficient to provide a desired thickness of the lubricant on the guide rails of the carriage box. In other embodiments, the excess amount Q2 may be determined theoretically based on surface property of the container, and fluid property of the mixture 310. In some embodiments, the excess amount Q2 of the lubricant is at least 20% more than the amount Q1 needed to cover a surface area of the guide rails in the carriage box 200 (e.g., Q2=0.2*Q1 or more). In other embodiments, the excess amount Q2 may be less than 20% of the amount Q1. Also, in some embodiments, the excess amount Q2 and the amount Q1 may be used to determine a plating efficiency parameter, which indicates the efficiency (e.g., how much of the provided lubricant gets delivered to the target surfaces) or non-efficiency (e.g., how much of the provided lubricant is lost) of the lubricant application method.

The solvent utilized in the lubrication mixture 310 is a substance that can dissolve and/or dilute the lubricant. In some cases, the solvent and the lubricant may be miscible. By means of non-limiting examples, the solvent may be Vertrel XF manufactured by Chemours, Hydrofluorocarbon (HFC) fluid, hydrochlorofluorcarbon (HCFC) fluid, perfluorocarbon (PFC) fluid, chlorinated solvent fluid, or any of other fluids that can dissolve and/or dilute the lubricant. The quantity (e.g., volume/weight) of solvent may be determined based on the surfaces to be lubricated. The fluid level of the solvent is sufficient such that when it is mixed with the lubricant, it dissolves and/or dilutes the lubricant and carries the lubricant to cover the entirety of the surfaces in the carriage box 200 desired to be lubricated. In one embodiment, a 3D model of the guide rails in the carriage box may be used to calculate the surface area and determine the quantity of solvent. In other embodiments, the quantity of solvent may be determined empirically using a model of the carriage box, or an actual carriage box.

The lubricant with pre-determined quantity and the solvent are mixed to create the lubrication mixture 310. They may be mixed thoroughly by shaking the container 300 prior to application.

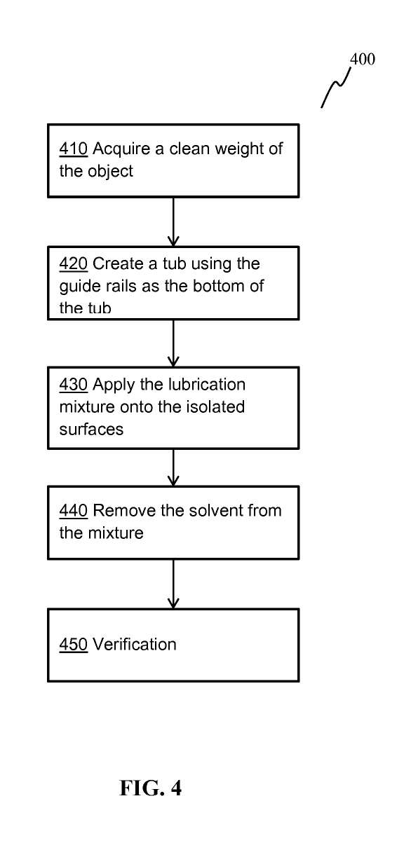

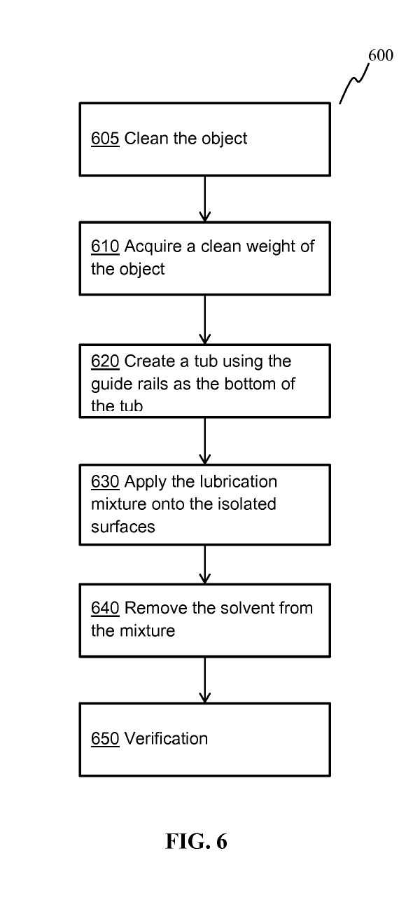

After a precise volume of the lubrication mixture 310 is prepared, the lubrication mixture 310 may be applied to an object with complex surfaces (e.g., to the guide rails on one or both sides 210, 220 of the carriage box 200) according to the application process described in connection with FIG. 4 or FIG. 6.

FIG. 4 is a flow chart illustrating a method 400 for application of a lubricant onto complex surfaces in a carriage box as a part of a manufacturing process of the carriage box or the collimator 24 that includes the carriage box. The carriage box may be the carriage box 200 described with reference to FIGS. 2A-2B.

At item 410, a clean weight of the carriage box to be lubricated is obtained by weighing the carriage box prior to application of the lubrication mixture 310. In one embodiment, the carriage box is weighed with a scale that measures to 0.01 gram precision. In one embodiment, the carriage box is weighed more than one time and the average weight is calculated as the clean or initial weight of the carriage box.

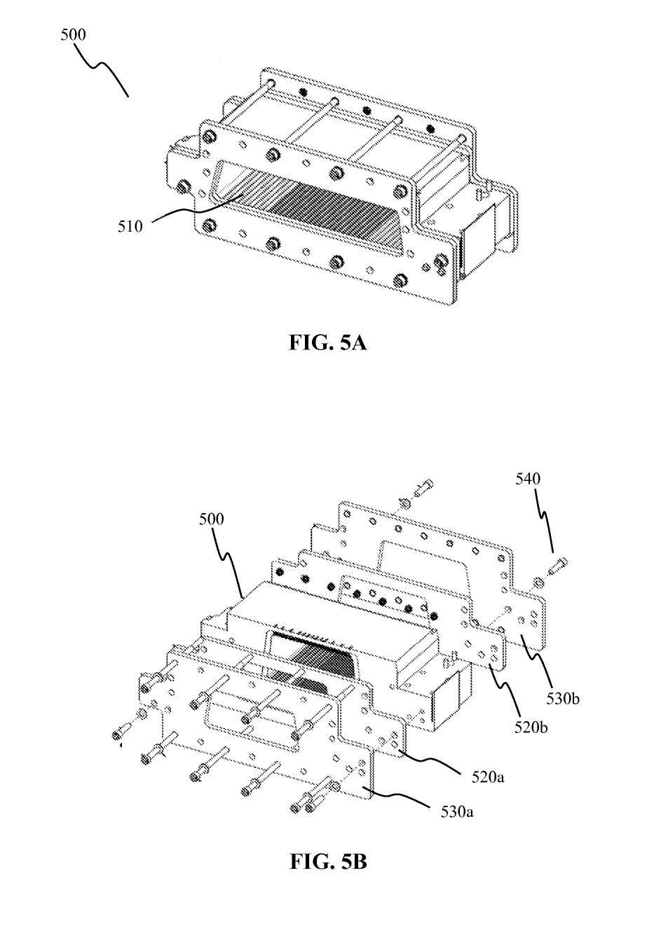

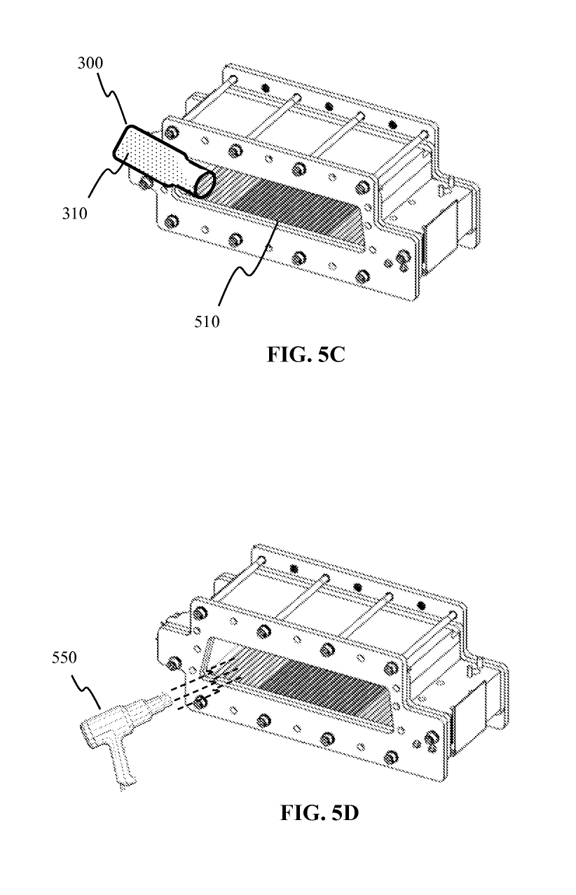

Next, a tub is created for the guide rails at item 420. In one embodiment, sealing components may be attached to the front and back of the carriage box to thereby create a tub for the guide rails. As an example, FIG. 5A shows guide rails 510 in a MLC carriage box 500 with sealing components being attached to the carriage box 500, and FIG. 5B is an exploded diagram of FIG. 5A, particularly showing the sealing components. The carriage box 500 may be the carriage box 200 described previously with reference to FIG. 2. As illustrated in FIG. 5B, the carriage box 500 is sandwiched with sealing components 520a and 520b (e.g., gaskets, O-rings, etc.). In particular, the sealing component 520a is abutted against a front side of the carriage box 500, and the sealing component 520b is abutted against a back side of the carriage box 500. The sealing components 520a and 520b are covered by respective plates 530a, 530b, and are affixed to the carriage box 500 with screws 540. The sealing components 520a, 520b are relatively flexible (e.g., compared to the plates 530a, 530b). Thus, the plates 530a, 530b are advantageous because they are more rigid than the sealing components 520a, 520b, thereby providing structural support for the sealing components 520a, 520b. In some embodiments, the sealing components 520a, 520b may be made from a flexible material, such as rubber, plastic, a polymer, or any of other materials. Also, in some embodiments, the plates 530a, 530b may be made from metal, alloy, ceramics, or any of other materials. As shown in the figure, by securing the sealing components 520a, 520b at the front and back, respectively, of the carriage box 500, a tub is created in which the guide rails 510 are the base of the tub, with the sealing components 520a, 520b forming the side walls at the front and back of the carriage box 500, and the sides of the carriage box 500 forming the side walls at the respective ends of the carriage box 500. The tub provides an isolated area for allowing the lubrication mixture 310 to be poured therein, and functions to contain the lubrication mixture 310 to prevent the lubrication mixture 310 from leaking and draining away from the surfaces of the guide rails 510. Thus, the tub essentially provides a static bath of the lubrication mixture 310.

As shown in the figure, the sealing components 520a, 520b, and the plates 530a, 530b have openings in the middle, which allow access to the guide rails 510 in the carriage box 500.

Referring back to FIG. 4, at item 430, the lubrication mixture (310 of FIG. 3) is applied onto the surfaces of the guide rails 510. In one embodiment as illustrated in FIG. 5C, the lubrication mixture 310 can be applied by pouring it from the container 300 onto the guide rails 510. In another embodiment, the lubrication mixture may be applied using an applicator, such as a syringe, a funnel, a brush, etc. Because the sealing components 520a, 520b, and the plates 530a, 530b have respective openings in the middle, a technician can apply the lubrication mixture 310 through the opening at the sealing component 520a, or through the opening at the sealing component 520b, onto the guide rails 510. The applied lubrication mixture 310 needs to be evenly distributed over the surfaces of the guide rails 510. In one embodiment, the carriage box 500 can be tilted back and forth and in different directions during the application process to ensure that the lubrication mixture 310 reaches the complex internal geometry of the guide rails 510. In another embodiment, the carriage box 500 can be oscillated or vibrated, e.g., using a mechanical vibrator or by hand, during the application process to more evenly distribute the lubrication mixture 310.

It should be noted that the tub created by the sealing components 520a, 520b is advantageous because it provides a static bath of lubrication mixture so that the lubricant in the lubrication mixture is in contact with the complex surfaces of the guide rails. Some lubrication techniques may not be able to reach complex surfaces of the guide rails, which have many fine grooves. The static bath of lubrication mixture allows the entire area of the guide rails to be soaked with the lubrication mixture 310, thereby ensuring that the complex surfaces of the guide rails are reached by the lubricant in the lubrication mixture 310. Also, the main factor involved in controlling the process is the amount of lubricant in the mixture, which is already pre-determined. Thus, the above technique does not involve process controlling factors that are difficult to implement.

Returning to FIG. 4, at item 440, the solvent in the lubrication mixture 310 is removed from the lubrication mixture 310, leaving behind a precise and uniform layer of lubricant on the surfaces of the guide rails 510 in the carriage box 500. As used in this specification, a layer of lubricant is considered “uniform” on a surface if the thickness of the layer does not vary by more than 30%, and more preferably 20%, and even more preferably 10%, across the surface. In some cases, the lubricant created on the surface of the guide rails 510 is viscous. In other cases, the lubricant created on the surface of the guide rails 510 may have other characteristics. In one embodiment, the solvent is evaporated using forced convection. For example, as illustrated in FIG. 5D, a heat gun 550 may be employed to blow against the applied mixture 310 to evaporate the solvent from the lubrication mixture 310. Optionally, the carriage box may be heated before and/or during the application process of the lubrication mixture 310 to speed up the evaporation process. In other embodiments, the removal of the solvent from the lubrication mixture 310 may be accomplished using a fan without heat, or using other forms of energy. Also, in further embodiments, the removal of the solvent from the lubrication mixture 310 may be accomplished without using any device—e.g., by letting the lubrication mixture 310 sit and allowing the solvent to evaporate by itself. In one implementation, the carriage box may be placed in a partial vacuum to speed evaporation.

Referring back to FIG. 4, next, verification may be performed at item 450 to verify the result of the lubrication application process. In one embodiment, an actual amount of the lubricant applied on the surfaces of the guide rails 510 may be verified by weighing the carriage box 500 after removing the solvent from the lubrication mixture 310 and comparing it to the clean or initial weight of the carriage box 500 measured prior to application (e.g., the clean or initial weight determined in item 410). In some cases, the clean or initial weight of the carriage box 500 is subtracted from the weight of the carriage box 500 with the lubricant to obtain a weight of the lubricant that has been applied onto the carriage box 500. If the weight of the lubricant is within a certain tolerance, then the weight criteria for the lubricant may be considered as passing. Alternatively or additionally, in item 450, the distribution of the lubricant applied on the carriage box 500 may be verified visually using an ultraviolet (UV) light source to ensure complete surface coverage. For example, in some cases, the mixture 310 in the container 300 may include particles that light up in response to UV light. These particles are dispersed in the mixture 310 and are mixed with the lubricant. Accordingly, after the lubricant is applied onto the carriage box 500, the UV light source may be used to apply UV light onto the guide rails 510 to see the distribution of these particles, which is indicative of the distribution of the applied lubricant. For example, if there is an area in the carriage box 500 that does not have any lubricant, that area will not light up in response to the UV light.

In some cases, the method 400 may optionally include cleaning the surfaces on which the lubricant is to be applied. The cleaning may be performed before item 410, or at any time before item 430. Also, the cleaning may be performed using alcohol, or a cleaning solution.

In some cases, the lubrication mixture involved in item 430 may be provided in a container (e.g., container 300). In some cases, the amount provided in the container 300 is for lubricating only the first set of guide rails at a first side of the carriage box 500. In other cases, the amount provided in the container is for lubricating both the first set of guide rails at the first side of the carriage box 500, and a second set of guide rails at a second side of the carriage box 500, the second side being opposite from the first side. In such cases, after the lubricant has been applied to the first set of guide rails, items 430, 440, 450 may be repeated for lubricating the second set of guide rails. When applying the lubrication mixture for the second set of guide rails, the carriage box 500 may be turned over so that the second set of guide rails becomes the bottom of the tub formed by the sealing components.

In some cases, if the amount provided in the container 300 is for lubricating only the first set of guide rails at the first side of the carriage box 500, an additional container (e.g., a second container) of lubrication mixture may be provided for lubricating the second set of guide rails at the second side of the carriage box 500. In such cases, items 430, 440, 450 may be repeated using the additional container of lubrication mixture for lubricating the second set of guide rails.

In the above embodiments, the container 300 of mixture 310 including the lubricant is described as being used for lubricating a MLC carriage box during a manufacturing process of the MLC carriage box or the MLC 24 containing the carriage box. In other embodiments, the container 300 of mixture 310 including the lubricant may be for use to fix an existing MLC. FIG. 6 is a flow chart illustrating an application method used in field for lubrication of an existing MLC carriage box (e.g., a MLC carriage box in a radiation system that has already been deployed in a hospital). The process 600 starts with cleaning the carriage box at item 605. In some cases, there may be widespread debris on the guide rails after an MLC has operated for a period of time. The debris may be due to failure of old lubrication (e.g., previous lubrication hardening and/or crusting due to interaction with radiation), due to particles coming off from the leaves and/or the guide rails resulting from friction that occurs during relative movement between the leaves and the guide rails, dirt, dust, or any combination of the foregoing. Therefore, the existing carriage box has to be cleaned to remove all undesirable materials on the guide rails prior to applying the new lubrication on the guide rails. In one embodiment, the carriage box and the guide rails are cleaned with a brush and alcohol (or a cleaning solution). In some embodiments, an ultrasonic cleaning may be employed to clean the carriage box. An ultrasonic cleaning is a process that uses ultrasound and an appropriate cleaning solvent (e.g., water or Vertrel) to clean the carriage box. The ultrasonic cleaning may last anywhere from 10 seconds to 20 minutes (e.g., 1 minute). In other embodiments, a pipe cleaner may be used to clean the guide rails. The pipe cleaner may fit snuggly into the guide rails and clean them by pulling the pipe cleaner through the rails. In other embodiments, other techniques may be used to clean the guide rails in an existing MLC carriage box. After cleaning, the subsequent processes are similar to the items described in connection with the method 400 of FIG. 4. In particular items 610, 620, 630, 640, 650 in FIG. 6 are similar to items 410, 420, 430, 440, 450 discussed with reference to FIG. 4. The descriptions of similar items are not repeated here for simplicity.

Also, in some embodiments, item 610 may be optional and may not be included in the method 600. For example, when applying the lubricant for an existing collimator in the field, the carriage box may not be weighted. In such cases, the applied lubricant may be assumed to be sufficient based on the consistency in the process of making the container of lubricating mixture. In one implementation, for a given model of collimator, the formula (e.g., in terms of the amount of lubricant, and the amount of solvent, therein) for creating the lubricating mixture is predetermined, and multiple containers of such lubricating mixtures are created for multiple respective collimators of the same model. As such, when the lubricating mixture is applied for the collimator of the same model, it may be assumed that the resulting lubricant on the carriage box will meet the required specification.

The above lubricating technique is advantageous because the resulting lubricant can stay with the collimator functionally for at least 5 years, and even 10 years, of the collimator's service life, as compared to old lubricating technique and old lubricant, which may fail after 1-2 years of the service life of the collimator. In some cases, the lubricant created on the guide rails may allow each leaf to travel at least a total distance of 12 km, and more preferably 18 km, and even more preferably 24 km.

In some embodiments, the lubricant created on the guide rails of the carriage box may withstand stress that is at least 0.6 ksi, and more preferably at least 2 ksi, and even more preferably 2.8 ksi or more (e.g., 2.9 ksi). Also, in some embodiments, the lubricant created on the guide rails may have a failure load that is greater than 4 kN, and more preferably greater than 15 kN, and even more preferably greater than 20 kN. Also, in some cases, the lubricant can withstand a range of humidity, such as 30-90% humidity. In addition, in some embodiments, the lubricant created on the guide rails can withstand radiation that is at least 1.8 to 2 Mrads (18-20 kGy), or a level of radiation dose that is based on a 10 year use case model (40 patients per day, and 5 days per week, for 10 years). Furthermore, in some cases, the lubricant can withstand temperature that is at least in the range of 35° C.-55° C., or beyond this range.

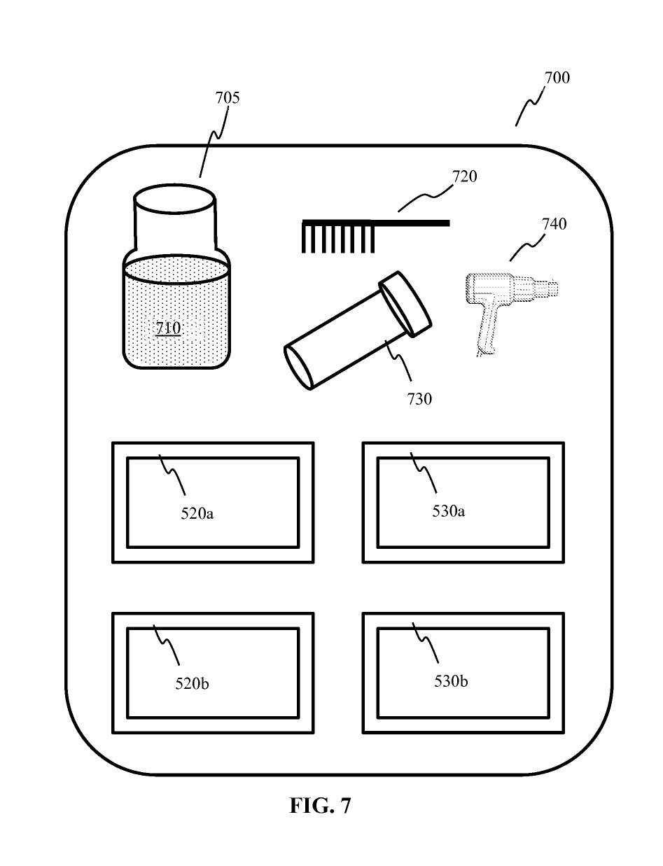

In some cases, the container 300 of mixture 310 may be provided as a part of a kit. FIG. 7 illustrates an exemplary MLC lubrication kit 700. The MLC lubrication kit 700 comprises a container 705 housing a lubrication mixture 710, a brush 720 and a UV light source 730. The lubrication mixture 710 may be the lubrication mixture 310 of FIG. 3, which includes a lubricant with a pre-determined quantity QT and a solvent. The lubrication mixture 310 may also optionally include particles that light up in response to ultraviolet light. The brush 720 is a cleaning brush for cleaning the debris in the guide rails or the carriage box prior to lubrication. In some cases, the brush 720 may be used in item 605 in the method 600 of FIG. 6. The UV light 730 may be used for verifying the distribution of the lubricant after the lubrication has been applied on the carriage box. The UV light 730 may be used in item 450/650. A heat source (e.g., heat gun) 740 is also included in the kit 700 for use to remove the solvent from the lubrication mixture 710. The heat source 740 may be used in item 440/640. In other embodiments, one or more of the items 720, 730, 740 may be optional, and the kit 700 may not include one or more of such items 720, 730, 740.

Also, in some embodiments, the kit 700 may optionally further include a first sealing component 520a, and a first plate 530a, which are described with reference to FIG. 5B. The first sealing component 520a is configured for abutment against a front side of a carriage box, while the first plate 530a provides support for the first sealing component 520a. The kit 700 may optionally further include a second sealing component 520b, and a second plate 530b, which are described with reference to FIG. 5B. The second sealing component 520b is configured for abutment against a back side of the carriage box, while the second plate 530b provides support for the second sealing component 520b. The kit 700 may also include hardware (e.g., screws) for securing the sealing components 520a, 520b and the plates 530a, 530b relative to the carriage box.

In some cases, the amount of lubricant provided in the container 705 is for lubricating only a first set of guide rails at a first side of a carriage box 500. In other cases, the amount of lubricant provided in the container 705 is for lubricating only a second set of guide rails at a second side of the carriage box 500, with the second side being opposite from the first side. In still other cases, the amount of lubricant provided in the container 705 is for lubricating both the first set of guide rails at the first side of the carriage box 500, and the second set of guide rails at the second side of the carriage box 500.

In some embodiments, if the amount provided in the container 705 is for lubricating only the first set of guide rails at the first side of the carriage box 500, the kit 700 may include an additional container (e.g., a second container) of lubrication mixture for lubricating the second set of guide rails at the second side of the carriage box 500.

In the above embodiments, the lubrication device and method have been described with reference to a carriage box having two sets of guide rails. In other embodiments, the lubrication device and method described herein may be used to lubricate a collimator having multiple sets of guide rails. For example, a collimator may have two carriage boxes with a total of four sets of guide rails. In such cases, the lubrication device and method described herein may be employed to lubricate such collimator. For example, the lubrication kit for lubricating such collimator may include a single container storing lubrication mixture for lubricating all four sets of guide rails, two containers each storing lubrication mixture for lubricating a pair of guide rails, or four containers storing lubrication mixtures for the respective four sets of guide rails. Also, a collimator may have more than two sets of guide rails that are not opposite from each other (e.g., split guides). The lubrication device and method described herein may also be employed to lubricate such collimator.

As discussed, in some embodiments, the lubricant in the lubrication mixture provided in the container 705 has a total quantity QT that is predetermined. In such cases, the lubrication mixture 710 may be applied to the carriage box by pouring the lubrication mixture 710 (e.g., most of the mixture 710 subject to some residual amount Q2 that may be lost due to the application process) into the carriage box. Alternatively, the lubrication mixture 710 may be applied to the carriage box using a syringe or an applicator. In any of the above techniques, the act of applying the lubrication mixture 710 will result in the predetermined quantity Q1 of lubricant being applied to the carriage box without the need for a user to explicitly measure an amount of the lubrication mixture 710 for application to the carriage box. This is because the excess amount Q2 (=QT-Q1) of the lubricant in the lubrication mixture 710 is already predetermined to account for loss of the mixture due to the application process. So the user can just follow a prescribed protocol to apply the mixture from the container 705 without the need to measure how much of the mixture to apply. In other embodiments, the total quantity of the lubrication mixture 710 provided in the container 705 may be any arbitrary amount, but the concentration of the lubricant (e.g., volume of lubricant/volume of mixture) may be predetermined. In such cases, the kit 700 may provide an instruction instructing a user of the kit 700 as to how much of the lubrication mixture 710 needs to be applied from the container 705 to the carriage box. For example, if the concentration is 0.8, and 8 mL of lubricant is needed, then the instruction may instruct the user to measure 10 mL of the mixture 710 for application to the carriage box, thereby resulting in 8 mL of the lubricant being applied. During use, the user may select a desired amount of the mixture 710 from the container (e.g., using a syringe with markings indicating volume of fluid being transferred, using a measuring cup, a weight, etc.), and transfer the selected amount of the mixture 710 from the container 705 to the carriage box.

It should be noted that embodiments herein have been described with reference to application of lubricant on guide rails in a carriage box in a multi-leaf collimator. However, it should be noted that the methods and systems described herein may be utilized for application of lubricant to any object.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly, to be regarded in an illustrative rather than restrictive sense. The claimed invention is intended to cover alternatives, modifications, and equivalents.

What is claimed is:

1. A method of applying a lubricant onto a carriage box of a collimator, comprising:
providing a mixture having a lubricant and a solvent;
applying an amount of the mixture that includes a predetermined quantity of the lubricant onto a first set of guide rails at a first side of the carriage box; and
removing the solvent from the mixture to leave the lubricant adhering to the surface.

2. The method of claim 1, wherein the solvent comprises Vertrel XF, Hydrofluorocarbon (HFC) fluid, hydrochlorofluorcarbon (HCFC) fluid, perfluorocarbon (PFC) fluid, or chlorinated solvent fluid.

3. The method of claim 1, wherein the lubricant comprises perfluoropolyether (PFPE), polyphenyl ether (PPE), Krytox XP 2A5, or Krytox XP 2A7.

4. The method of claim 1, wherein the mixture is provided in a container, and wherein the act of applying comprises transferring the amount of the mixture from the container to the carriage box without requiring a user to measure the amount of the mixture.

5. The method of claim 1, wherein the mixture is provided in a container, and wherein the method further comprises measuring the amount of the mixture to be transferred from the container to the carriage box, the amount of the mixture to be transferred being less than a total amount of the mixture in the container.

6. The method of claim 1, wherein the mixture is provided in a container, and a total quantity of the mixture in the container has a sufficient amount of the lubricant to cover a first surface area of the first set of slots, a second surface area of a second set of slots at a second side of the carriage box, or both the first surface area and the second surface area.

7. The method of claim 1, wherein the mixture is provided in a container, a total quantity of the lubricant in the container being greater than the predetermined quantity by an excess amount.

8. The method of claim 1, wherein the act of applying the mixture is distributed evenly over the surface by tilting or oscillating the collimator carriage box.

9. The method of claim 1, further comprising verifying a distribution of the lubricant on the carriage box.

10. The method of claim 9, wherein the distribution of the lubricant is verified by using an ultraviolet light source.

11. The method of claim 1, further comprising determining an amount of the lubricant applied on the first set of guide rails.

12. The method of claim 1, further comprising cleaning the carriage box before applying the mixture onto the first set of guide rails.

13. The method of claim 1, further comprising applying the mixture onto a second set of guide rails at a second side of the carriage box, the second side being opposite from the first side.

14. The method of claim 1, wherein the mixture is provided in a first container, and wherein the method further comprises:
providing an additional mixture in a second container; and
applying at least some of the additional mixture onto a second set of guide rails at a second side of the carriage box, the second side being opposite from the first side.

15. The method of claim 1, further comprising:
securing a first sealing component to a front side of the carriage box; and
securing a second sealing component to a back side of the carriage box;
wherein the first sealing component and the second sealing component, together with the first set of guide rails, form a tub.

16. The method of claim 15, wherein the first sealing material comprises an opening.

17. A collimator, comprising:
a carriage box having a first side and a second side opposite from the first side, the carriage box having a first plurality of slots at the first side for moveably accommodating respective leaves; and
a lubricant comprising perfluoropolyether (PFPE) distributed on a surface area of the slots.

18. The collimator of claim 17, wherein the carriage box has a second plurality of slots at the second side for accommodating the leaves.

19. The collimator of claim 17, further comprising the leaves, wherein the leaves are moveably disposed in the respective slots.

20. The collimator of claim 17, wherein the lubricant has a thickness that is less than 12 microns.

21. The collimator of claim 17, wherein the lubricant comprises particles that light up in response to ultraviolet light.

22. A kit for lubricating a collimator, comprising:
a container housing a lubricating mixture having a lubricant mixed in a solvent;
wherein a quantity of the lubricant in the lubricating mixture is predetermined based, at least in part, on a first surface area of a first set of guide rails at a first side of a carriage box, a second surface area of a second set of guide rails at a second side of the carriage box opposite from the first side, or both the first surface area and the second surface area.

23. The kit of claim 22, wherein the lubricant comprises perfluoropolyether (PFPE), polyphenyl ether (PPE), Krytox XP 2A5 or Krytox XP 2A7.

24. The kit of claim 22, wherein the solvent comprises Vertrel XF, Hydrofluorocarbon (HFC) fluid, hydrochlorofluorcarbon (HCFC) fluid, perfluorocarbon (PFC) fluid, or chlorinated solvent fluid.

25. The kit of claim 22, further comprising a brush for cleaning the carriage box.

26. The kit of claim 22, wherein the lubricating mixture comprises particles that light up in response to ultraviolet light.

27. The kit of claim 26, further comprising an ultraviolet light source for providing the ultraviolet light.

28. The kit of claim 22, further comprising a first sealing component for abutment against a front side of the carriage box.

29. The kit of claim 28, further comprising a first plate for supporting the first sealing component.

30. The kit of claim 28, further comprising a second sealing component for abutment against a back side of the carriage box.

31. The kit of claim 28, wherein the quantity of the lubricant in the lubricating mixture has a first amount that is sufficient to cover at least the first surface area of the first set of guide rails, the second surface area of the second set of guide rails, or both the first surface area and the second surface area.

32. The kit of claim 31, wherein the quantity of the lubricant in the lubricating mixture has a second amount that is in addition to the first amount, wherein the first amount and the second amount constitute a total amount of the quantity of the lubricant in the lubricating mixture.

33. A kit for lubricating an object, comprising:
a container housing a lubricating mixture having a lubricant mixed in a solvent;
wherein a quantity of the lubricant in the lubricating mixture is predetermined based, at least in part, on a surface area of the object that is desired to be lubricated.

34. A method of applying a lubricant onto an object, comprising:
providing a mixture having a lubricant and a solvent;
applying a predetermined quantity of the mixture onto a surface of the object; and
removing the solvent from the mixture to leave the lubricant adhering to the surface of the object.
